(19) United States
(12) Patent Application Publication
(10) Pub. No.: US 2016/0218363 A1
(43) Pub. Date: Jul. 28, 2016

(54) LITHIUM AND SODIUM CONTAINING LAYERED OXIDE MATERIAL, CATHODES AND SODIUM ION ELECTROCHEMICAL CELLS

(71) Applicant: THE REGENTS OF THE UNIVERSITY OF CALIFORNIA, Oakland, CA (US)

(72) Inventors: Ying Shirley MENG, La Jolla, CA (US); Haodong LIU, La Jolla, CA (US)

(21) Appl. No.: 14/917,340

(22) PCT Filed: Sep. 5, 2014
(86) PCT No.: PCT/US2014/054251

§ 371 Date: Mar. 8, 2016

Related U.S. Application Data
(60) Provisional application No. 61/875,456, filed on Sep. 9, 2013.

(51) Int. Cl. H01M 4/505; H01M 4/62; H01M 10/0568; H01M 10/0569; H01M 4/525; H01M 10/054

(52) U.S. Cl. CPC H01M 4/505; H01M 4/525; H01M 10/054; H01M 10/0568; H01M 10/0569; H01M 4/623; H01M 2004/028

(57) ABSTRACT

Cathode materials and cathodes for sodium and sodium-ion cells and batteries include sodium, lithium and transition metal oxide cathode materials. An example cathode is the composition NaₓLi_{y}Ni_{z}MnᵤMᵥO_{w}, with M being one or more metal cation, x+y≧0.9, (x+y)/(z+u+v)>1, (z+u+v)>1, 0≦z≦0.9, 0≦u≦0.9, 0≦v≦0.9, x+y+z+u+v is less than w, and the value of w depends on the proportions and average oxidation states of the metallic elements. The combined positive charge of the metallic elements is balanced by the number of oxygen anions, w. W is less than or equal to 2, i.e., NaₓLi_{y}Ni_{z}MnᵤMvO₂₋ₐ, and desirably equal to or slightly less than 2. M is one or more metal cations selected preferably from one or more divalent, trivalent, tetravalent, pentavalent or hexavalent cations, such as Mg²⁺, Cu²⁺, Co³⁺, B³⁺, Fe³⁺, Al³⁺, Ti⁴⁺, Zr⁴⁺, V⁵⁺, and Cr⁶⁺ etc. Synthesis methods are provided.

### PRIORITY CLAIM AND REFERENCE TO RELATED APPLICATION

The application claims priority under 35 U.S.C. §119 and applicable treaties from prior U.S. provisional application Ser. No. 61/875,456, which was filed Sep. 9, 2013.

### STATEMENT OF GOVERNMENT INTEREST

This invention was made with government support under Award Number DE-SC0001294 from U.S. Department of Energy, Office of Basic Energy Sciences. The government has certain rights in the invention.

### FIELD OF THE INVENTION

The field of the invention is energy storage devices, particularly non-aqueous electrochemical cells and batteries and, more particularly, non-aqueous rechargeable sodium electrochemical cells and batteries. Rechargeable ambient temperature sodium and sodium ion batteries of the invention are applicable to many energy storage applications, especially large-scale stationary electrical storage for electrical grid. Other example applications include, but are not limited to portable device, transportation, defense products, and aerospace products.

### BACKGROUND

Worldwide demand to develop electrical energy storage is growing as a result of increased energy demand, rapid increases in the price of fossil fuels and the environmental consequences of their use. Renewable energy technologies such as wind and solar generated electricity are have great potential to generate energy. However, the renewable sources are not able to generate energy on demand in a manner that models traditional power plants. Wider success of the renewable sources therefore requires better energy storage systems.

Large-scale stationary electrical storage requires new battery systems, as current technology is ill-suited for this application.[1] Extensive research has focused on the lithium system for rechargeable batteries. The lithium system is in widespread use for small power consumption devices, such as electronics. It has also been adopted in electrically powered automobiles. The lithium is favored for its high energy and power density. Most research efforts are devoted to improving the lithium system for safety, power output, discharge cycle, and lifetime. Despite the widespread adoption of the lithium system, the energy, power density, lifetime, and costs are not well-suited for energy storage in a power distribution system. The limits of current lithium system technology also places a ceiling on performance of current applications, such as electrically powered vehicles.

In contrast, sodium intercalation chemistry has been explored considerably less than lithium intercalation system. Artisans have likely avoided the sodium battery system due to the lack of a high energy density cathode material that is safe and low cost.

Sodium is located below lithium in the periodic table. Sodium and lithium show similar chemical properties in many aspects. The fundamental principles of the sodium ion battery and lithium ion battery are identical, during charge and discharge the alkali ions move back and forth between the two electrodes. Sodium is available in high abundance and low cost, and has a very suitable redox potential (E^{Θ}_{Na+/Na}=−2.7V only 0.3 V above that of E^{Θ}_{Li+/Li}=−3.0V).

The abundance and low cost of Na in the earth can become an advantage when a large amount of alkali is demanded for large-scale applications. Research on sodium ion batteries began in the late 1970s and the early 1980s. [2-4] Sodium-based layered electrode materials can be categorized into two main groups[5]: O3 type or P2 type, in which the sodium ions are accommodated at octahedral and prismatic sites, respectively. A study by Lu and Dahn demonstrated that the P2-layered oxide, Na_{2/3}[Ni_{1/3}Mn_{2/3}]O2, can reversibly exchange Na-ions in sodium cells [6, 7], but the voltage profile was complicated, showing single and two phase regions, and transformation to O2 structure at high voltage range. More recently, Li substituted Na_{1.0}Li_{0.2}Ni_{0.25}Mn_{0.75}O₂ was studied by Kim et al. and displayed 95 mAh g⁻¹ of specific capacity, excellent cycling and rate capabilities[8]. The TM layer is argued to improve the structural stability during the cycling.

Other P2-type phases provide higher capacity as electrode materials. P2-Na_{0.6}MnO₂ delivers a large initial capacity of 160 mAh g⁻¹ [9], P2-Na_{2/3}Fe_{0.5}Mn_{0.5}O₂ delivers higher initial capacity of 190 mAh g⁻¹ [10]. However the cyclability is insufficient.

O3-phases such as NaCoO₂ [3], NaCrO₂ [11], NaVO₂ [12], and NaNi_{0.5}Mn_{0.5}O₂ [13] are electrochemically active, but the repeatable reversible capacity cannot exceed 120 mAh g⁻¹. Recently, Tarascon successfully synthesized O3-phase NaNi_{1/3}Mn_{1/3}Co_{1/3}O₂ which can deliver a reversible capacity of 120 mAh g⁻¹. Their voltage profile shows complicated phase transformation during charge, followed the sequence O3→O1→P3→P1 which was proved by their in-situ XRD work.[14]

### REFERENCES

[1] Z. G. Yang, J. L. Zhang, M. C. W. Kintner-Meyer, X. C. Lu, D. W. Choi, J. P. Lemmon, J. Liu, Chem Rev, 111 (2011) 3577-3613.
[2] M. S. Whittingham, Prog Solid State Ch, 12 (1978) 41-99.
[3] C. Delmas, J. J. Braconnier, C. Fouassier, P. Hagenmuller, Solid State Ionics, 3-4 (1981) 165-169.
[4] J. M. Tarascon, Solid State Ionics, 18-9 (1986) 768-772.
[5] C. Delmas, C. Fouassier, P. Hagenmuller, Physica B & C, 99 (1980) 81-85.
[6] Z. H. Lu, J. R. Dahn, Journal of The Electrochemical Society, 148 (2001) Al225-Al229.
[7] Z. H. Lu, J. R. Dahn, Journal of The Electrochemical Society, 148 (2001) A710-A715.
[8] D. Kim, S. H. Kang, M. Slater, S. Rood, J. T. Vaughey, N. Karan, M. Balasubramanian, C. S. Johnson, Advanced Energy Materials, 1 (2011) 333-336.
[9] A. Caballero, L. Hernan, J. Morales, L. Sanchez, J. S. Pena, M. A. G. Aranda, Journal of Materials Chemistry, 12 (2002) 1142-1147.
[10] N. Yabuuchi, M. Kajiyama, J. Iwatate, H. Nishikawa, S. Hitomi, R. Okuyama, R. Usui, Y. Yamada, S. Komaba, Nature materials, 11 (2012) 512-517.
[11] S. Komaba, C. Takei, T. Nakayama, A. Ogata, N. Yabuuchi, Electrochemistry Communications, 12 (2010) 355-358.
[12] C. Didier, M. Guignard, C. Denage, O. Szajwaj, S. Ito, I. Saadoune, J. Darriet, C. Delmas, Electrochem Solid St, 14 (2011) A75-A78.
[13] S. Komaba, W. Murata, T. Ishikawa, N. Yabuuchi, T. Ozeki, T. Nakayama, A. Ogata, K. Gotoh, K. Fujiwara, Advanced Functional Materials, 21 (2011) 3859-3867.
[14] M. Sathiya, K. Hemalatha, K. Ramesha, J. M. Tarascon, A. S. Prakash, Chemistry of Materials, 24 (2012) 1846-1853.
[15] M. S. Whittingham, Chem Rev, 104 (2004) 4271-4301.
[16] D. H. Lee, J. Xu, Y. S. Meng, Phys Chem Chem Phys, 15 (2013) 3304-3312.

### SUMMARY OF THE INVENTION

Embodiments of the invention include cathode materials and cathodes for sodium and sodium-ion cells and batteries including sodium, lithium and transition metal oxide cathode materials. In a preferred embodiment, the cathode is from of the composition NaₓLi_{y}Ni_{z}MnᵤMᵥO_{w}, with M being one or more metal cation, x+y≧0.9, (x+y)/(z+u+v)>1, O≦z≦0.9, O≦u≦0.9, 0≦v≦0.9, x+y+z+u+v is less than w, and the value of w depends on the proportions and average oxidation states of the metallic elements. The combined positive charge of the metallic elements is balanced by the number of oxygen anions, w. In preferred embodiments, w is less than or equal to 2, i.e., NaₓLi_{y}Ni_{z}MnᵤMᵥO₂₋ₐ, and preferably equal to or slightly less than 2. M is one or more metal cations selected preferably from one or more divalent, trivalent, tetravalent, pentavalent or hexavalent cations, such as Mg²⁺, Cu²⁺, Co³⁺, B³⁺, Fe³⁺, Al³⁺, Ti⁴⁺, Zr⁴⁺, V⁵⁺, and Cr⁶⁺ etc. The cathode material has a layered structure in which the Na is predominately present in sodium layer, and Ni, Mn and M are predominately present in a transition metal layer. The position of Li depends on the content of Li in the compounds, it can be present in sodium or transition metal layers or both, and it can also be present between the sodium and transition metal layers. In preferred embodiments, the Li content is 0.4 or less and preferably 0.2, or less. Preferred methods of forming electrode materials and electrodes of the invention include solid state mixing, co-precipitation reaction, calcination methods and ion exchange methods.

### BRIEF DESCRIPTION OF THE DRAWINGS

FIG. 1 shows a schematic representation of a preferred embodiment NaₓLi_{y}Ni_{z}MnᵤMᵥO_{w} structure, which is layered with sodium cations in the octahedral coordination between the close-packed stacked oxygen anions layers; the crystal structure contains a hexagonal unit cell with ABCABC close-packed oxygen anions;

FIG. 2 illustrates X-ray diffraction patterns of Na_{0.05}Li_{1.15}Ni_{0.2}Mn_{0.6}O₂ compounds, with a preferred O3 layered structure;

FIG. 3 illustrates a first charge-discharge profile of a preferred Li/Na_{0.05}Li_{1.15}Ni_{0.2}Mn_{0.6}O₂ cell at 12.5 mA/g over a voltage range of between 4.8V and 2.0V vs. Li metal;

FIG. 4 illustrates the X-ray diffraction pattern of the preferred Na_{0.8}Li_{0.14}Ni_{0.3}Mn_{0.567}O_{w} cathode material extracted from a cell with Al current collector after one cycle vs. Na metal, with the O3 layered structure;

FIG. 5A illustrates a discharge profile of a preferred Na/Na_{0.8}Li_{0.14}Ni_{0.3}Mn_{0.567}O_{w} cell at 12.5 mA/g to 1.5V vs. Na metal; FIG. 5B illustrates charge-discharge profiles of following cycles of the preferred Na/Na_{0.8}Li_{0.14}Ni_{0.3}Mn_{0.567}O_{w} cell at different current density over a voltage range of between 4.5V and 1.5V vs. Na metal;

FIG. 6A is a TEM image of conventional cathode Li_{1.13}Ni_{0.3}Mn_{0.567}O₂ cathode material extracted from a cell after one cycle vs. Li metal; FIG. 6B is a TEM image of preferred Na_{0.8}Li_{0.14}Ni_{0.3}Mn_{0.567}O_{w} cathode material extracted from a cell after one cycle vs. Na metal;

FIG. 7 illustrates an EDX pattern of preferred Na_{0.8}Li_{0.14}Ni_{0.3}Mn_{0.567}O_{w} cathode material extracted from a cell after one cycle vs. Na metal;

FIG. 8A illustrates a discharge profile of a preferred Na/Na_{0.8}Li_{0.14}Ni_{0.25}Mn_{0.583}O_{w} cell at 12.5 mA/g to 1.5V vs. Na metal; FIG. 8B illustrates the discharge capacity vs cycles of the preferred Na/Na_{0.8}Li_{0.14}Ni_{0.25}Mn_{0.583}O_{w} cell at 125 mA/g for 12 cycles, then change to 1.25 A/g over a voltage range of between 4.2V and 1.5V vs. Na metal; FIG. 8C illustrates a comparison of the charge-discharge profile of the preferred Na/Na_{0.8}Li_{0.14}Ni_{0.25}Mn_{0.583}O_{w} cell at different current density over a voltage range of between 4.2V and 1.5V vs. Na metal;

FIG. 9 illustrates the synchrotron X-ray diffraction pattern (converted to Cu Ka) of the Na_{0.8}Li_{0.14}Ni_{0.25}Mn_{0.583}O_{w} cathode material extracted from a cell at different state of charge over a voltage range of between 4.2V and 1.5V vs. Na metal, with the O3 layered structure.

FIG. 10A illustrates a discharge profile of a preferred Na/Na_{0.8}Li_{0.14}Ni_{0.16}Mn_{0.5}O_{w} cell at 12.5 mA/g to 1.5V vs. Na metal; FIG. 10B illustrates a comparison of the charge-discharge profile of Na/Na_{0.8}Li_{0.16}Ni_{0.5}Mn_{0.583}Co_{0.16}O_{w} cell at 125 mA/g over a voltage range of between 4.2V and 1.5V vs. Na metal at different cycles;

FIG. 11 illustrates the X-ray diffraction pattern of the preferred Na_{0.8}Li_{0.16}Ni_{0.5}Mn_{0.583}Co_{0.16}O_{w} cathode material extracted from a cell with Al current collector after cycles at 125 mA/g over a voltage range of between 4.2V and 1.5V vs. Na metal, with the O3 layered structure;

FIG. 12A illustrates a charge-discharge profile of a preferred SnS₂-rGO/Na_{0.8}Li_{0.14}Ni_{0.25}Mn_{0.583}O_{w} fuel cell at 17 mA/g over a voltage range of between 4.2V and 1.0V vs. SnS₂-rGO; FIG. 12B illustrates the discharge capacity vs cycles of the preferred SnS₂-rGO/Na_{0.8}Li_{0.14}Ni_{0.25}Mn_{0.583}O_{w} full cell at 17 mA/g over a voltage range of between 4.2V and 1.0V vs. SnS₂-rGO (reduced graphene oxide);

FIG. 13 illustrates X-ray diffraction patterns of NaLi_{0.133}Ni_{0.2}Mn_{0.467}Co_{0.2}O₂ compounds, with the O3 layered structure;

FIG. 14 illustrates a charge-discharge profile of a preferred Na/NaLi_{0.133}Ni_{0.2}Mn_{0.467}Co_{0.2}O₂ cell at 25 mA/g over a voltage range of between 4.5V and 1.5V vs. Na metal;

FIG. 15A is a schematic diagram of a preferred embodiment battery of the invention; and

FIG. 15B is a schematic diagram of a preferred embodiment fuel cell of the invention.

### DETAILED DESCRIPTION OF THE PREFERRED EMBODIMENTS

Embodiments of the invention provide cathode material, cathodes for energy storage devices and energy storage devices. Preferred embodiments provide non-aqueous electrochemical cells and batteries and, more particularly, non-aqueous rechargeable sodium and sodium ion electrochemical cells and batteries. Cells of the invention can operate at ambient temperature. Preferred embodiments also provide fuel cells including sodium, lithium and transition metal oxide cathode materials.

Preferred embodiments of the invention mix sodium-lithium nickel-manganese (or nickel-manganese-cobalt) metal oxide layered materials have been identified for use as cathode in ambient temperature sodium ion batteries.

Preferred embodiments of the invention provide cathode materials and cathodes for sodium and sodium-ion cells and batteries including sodium, lithium and transition metal oxide cathode materials. In a preferred embodiment, the cathode is from of the composition NaₓLi_{y}Ni_{z}MnᵤMᵥO_{w}, with M being one or more metal cation, x+y≧0.9, (x+y)/(z+u+v)>1, 0≦z≦0.9, 0≦u≦0.9, 0≦v≦0.9, x+y+z+u+v is less than w, and the value of w depends on the proportions and average oxidation states of the metallic elements. The combined positive charge of the metallic elements is balanced by the number of oxygen anions, w. In preferred embodiments, w is equal to or less than 2, i.e., NaₓLi_{y}Ni_{z}MnᵤMᵥO₂₋ₐ, and preferably equal to or slightly less than 2. M is one or more metal cations selected preferably from one or more divalent, trivalent, tetravalent, pentavalent or hexavalent cations, such as Mg²⁺, Cu²⁺, Co³⁺, B³⁺, Fe³⁺, Al³⁺, Ti⁴⁺, Zr⁴⁺, V⁵⁺, and Cr⁶⁺, and Cr⁶⁺ etc. The cathode material has a layered structure in which the Na is predominately present in sodium layer, and Ni, Mn and M are predominately present in a transition metal layer. The position of Li depends on the content of Li in the compounds, it can be present in sodium or transition metal layers or both, and it can also be present between the sodium and transition metal layers. The Li in the preferred material is 0.4 or less and most preferably 0.2 or less. This provides an advantage compared to the Li content in lithium ion battery cathodes, which is usually 1. The lower content of Li lowers the cost of cathodes produced by the invention. The Li ions in TM layer pin the oxygen layers by allowing the so-called tetrahedron dumbbell formation, in which the tetrahedral sites formed between the oxygen AB stacked layers can be occupied by either Li ion or Ni and Mn ions. The oxidation states of the Ni and Mn components are predominantly divalent and tetravalent, respectively.

A preferred method for formation of the cathode material includes thermal reaction of co-precipitated transition metal hydroxide/ carbonate precursors (including directly mixed transition metal oxides) mixed with sodium carbonate and lithium hydroxide/ carbonate or ion exchange with as-prepared O3 phase lithium transition metal oxides. Preferably, the NaₓLi_{y}Ni_{z}MnᵤMᵥO_{w} is present in a layer or casting on a current collector such as a metallic substrate (e.g., Al foil).

Preferred embodiments provide cathodes that are rich in sodium and manganese. The preferred cathodes are low in cost compared to similar lithium metal oxide compounds, and exhibit high power, high energy, and long cycle life times. Advances provided by cathodes and energy storage devices of the invention provide an attractive model for wide spread use of sodium and sodium ion batteries in many applications that presently rely upon the lithium system.

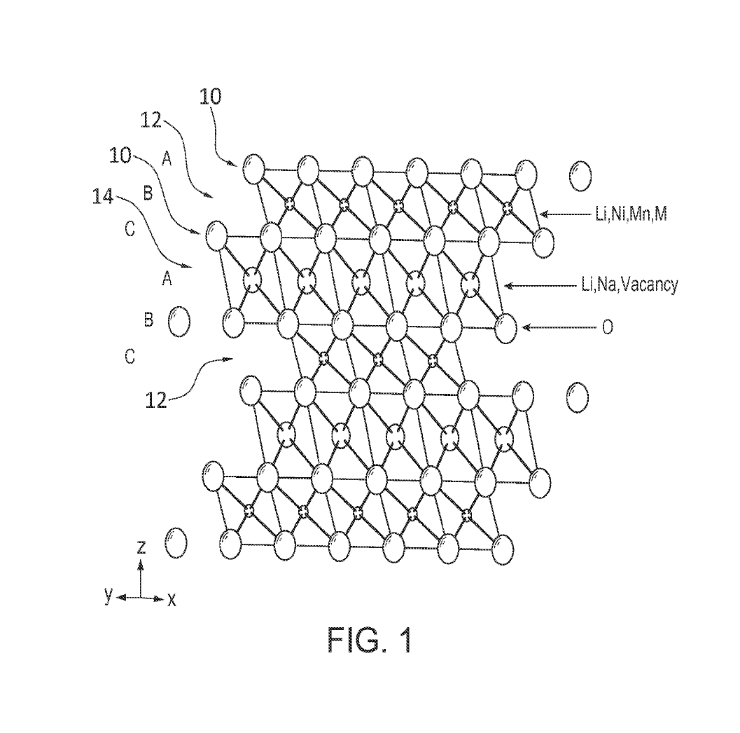

FIG. 1 shows a schematic representation of a preferred embodiment NaₓLi_{y}Ni_{z}MnᵤMᵥO_{w} structure, which is layered with sodium cations in the octahedral coordination between the close-packed stacked oxygen anions layers. The crystal structure contains a hexagonal unit cell with ABCABC close-packed oxygen anions. Specifically, an A layer 10 is oxygen, a B layer is Li, Ni, Mn, M, and a C layer is oxygen 10. The second ABC group is then an Li, Na, Vacancy layer 14, followed by oxygen 10 as a B layer and Li, Ni, Mn, M as a C layer.

Preferred embodiment cathodes possess high-energy and high-power capabilities and can be used in rechargeable sodium and sodium ion cells and batteries that include a suitable anode and electrolyte (e.g., sodium metal anode, tin sulfite anode and sodium salt electrolyte) to form a full cell that is most preferably used in ambient temperature sodium electrochemical cells and batteries.

Preferred example cathode materials have been prepared in experiments. The example preferred materials have the general composition NaₓLi_{y}Ni_{z}MnᵤMᵥO_{w}, for example Na_{0.05}Li_{1.15}Ni_{0.2}Mn_{0.6}O₂, Na_{0.8}Li_{0.14}Ni_{0.3}Mn_{0.567}O_{w}, Na_{0.8}Li_{0.14}Ni_{0.25}Mn_{0.583}O_{w}, Na_{0.8}Li_{0.14}Ni_{0.16}Mn_{0.5}Co_{0.16}O_{w}, and NaLi_{0.133}Ni_{0.2}Mn_{0.467}Co_{0.2}O₂. These materials are layered structures and were investigated as cathode active materials for sodium and sodium ion batteries. In these examples, the Na cations are predominately present in octahedral coordination in sodium layer, the Ni, Mn and M cations are preferentially located in octahedral coordination in the transition metal layer, and the Li cations are located in octahedral coordination in either transition metal layer or both transition metal layer and sodium layer depends on the amount of lithium ion in the structure. Preferably, the mixing between Na and transition metal cations is minimal and most preferably non-existent. Preferred prepared materials are believed to have had no Na/transition metal mixing. Li and Na can be in the same layer of the structure, however (at a relatively high state of charge). The metal stoichiometries were selected to include Li so that stabilize the O3 structure during electrochemical cycling. In lithium ion batteries, the charge-ordered state is known to stabilize the structure to reversible insertion/extraction of lithium between the TM layers.[15]

Preferred embodiments provide an cathode for sodium or sodium ion electrochemical cells and batteries and cells and batteries including the cathodes. The cathode comprises a material of composition NaₓLi_{y}Ni_{z}MnᵤMᵥO_{w}, where M compromises one or more metal cation, x+y>0.9, (x+y)/(z+u+v)>1, 0≦z≦0.9, 0≦u≦0.9, 0≦v≦0.9, x+y+z+u+v is less than w, and the value of w depends on the proportions and average oxidation states of the metallic elements. The combined positive charge of the metallic elements is balanced by the number of oxygen anions, w. The cathode material of composition NaₓLi_{y}Ni_{z}MnᵤMᵥO_{w} is layered, with preferably good separation between the layers. The Na cations are predominately present in octahedral coordination in sodium layer, the Ni, Mn and M cations are preferentially located in octahedral coordination in the transition metal layer, and the Li cations are located in octahedral coordination in either transition metal layer or both transition metal layer and sodium layer depends on the amount of lithium ion in the structure. The Li ions in TM layer pin the oxygen layers by allowing the so called tetrahedron dumbbell formation, the tetrahedral sites formed between the oxygen AB stacked layers can be occupied by either Li ion or Ni and Mn ions. They provide a pivoting role for preventing the oxygen layer shifting from AB (in O3 structure) to AA (in P2/P3 structure). In a preferred embodiment, little or no site-disorder takes place between the Na in sodium layers. The presence of Li in the structure beneficially leads to excellent electrochemical performance. This is associated with the structure's stability against phase transformation and a possibly correlated enhancement of Na ion diffusion therein, as observed by Meng et al in P2-Naₓ[Ni_{1/3}Mn_{2/3}]O₂[16]. In a particular preferred embodiment, the NaₓLi_{y}Ni_{z}MnᵤMᵥO_{w} is present in a layer or casting on a current collector such as a metallic substrate (e.g., Al foil).

A preferred cathode for an electrochemical cell of the invention comprises an active material of composition NaₓLi_{y}Ni_{z}MnᵤMᵥO_{w}. In one preferred embodiment, v/w is 0, (x+y)/w is about 0.6, and (z+u)/w is about 0.4. In another preferred embodiment, v/w is 0, (x+y)/w is about 0.47, and (z+u)/w is about 0.433. In a third preferred embodiment, v/w is 0, (x+y)/w is about 0.47, and (z+u)/w is about 0.417. In a fourth preferred embodiment, v/w is about 0.08, (x+y)/w is about 0.47, and (z+u)/w is about 0.33. In a fifth preferred embodiment, v/w is about 0.1, (x+y)/w is about 0.567, and (z+u)/w is about 0.334.

In one preferred embodiment, ratio u/z is about 1.9, x/y is about 5.7, and (x+y)/ (z+u) is about 1.5, and the exists of Na, Ni and Mn in cathode material which extracted from cycled cathode are determined by EDX

In some preferred embodiments, M comprises one or more metal cations selected preferably from one or more divalent, trivalent, tetravalent, pentavalent or hexavalent cations, such as Mg²⁺, Cu²⁺, Co³⁺, B³⁺, Fe³⁺, Al³⁺, Ti⁴⁺, Zr⁴⁺, V⁵⁺, and Cr⁶⁺ etc. In preferred embodiments, Na is predominately present in sodium layer, and Ni, Mn and M are predominately present in a transition metal layer. Li is present in both sodium and transition metal layers. The Li ions reside in the TM layer, providing a pivoting role for preventing the oxygen layer shifting from AB (in O3 structure) to AA (in P2/P3 structure). The Li ions in TM layer pin the oxygen layers by allowing the so called tetrahedron dumbbell formation, the tetrahedral sites formed between the oxygen AB stacked layers can be occupied by either Li ion or Ni and Mn ions.

In preferred embodiment cathodes, Na cations are predominately present in octahedral coordination in the sodium layer, the Ni, Mn and M cations are preferentially located in octahedral coordination in the transition metal layer, and the Li cations are located in octahedral coordination in either transition metal layer or both transition metal layer and sodium layer depends on the amount of lithium ion in the structure. The Li present in transition metal layer, which makes local Li₂MnO₃ like character and preferably clusters with Ni and/or Mn. Preferably, the NaₓLi_{y}Ni_{z}MnᵤMᵥO_{w} exhibits a layering peak in the X-ray diffraction (XRD) pattern thereof, and also preferably has a repeating ABCABC layered, oxygen close-packed stacking structure.

In some preferred embodiments, the first electrochemical charge profile of the cathode exhibits a plateau at about 4.5V when used as the cathode in an electrochemical cell including a Li metal anode and an electrolyte including 1 M LiPF₆ in a mixture of ethylenecarbonate (EC) and dimethylcarbonate (DMC) in a weight ratio of about 1:1 EC:DMC.

Preferred cathode materials of NaₓLi_{y}Ni_{z}MnᵤMᵥO_{w} can be prepared by a number of procedures, including solid state, co-precipitation, sol-gel, polyol, and hydrothermal methods. The co-precipitation and solid state methods are more readily scalable.

A preferred solid state method utilizes oxides, carbonate, hydroxides, or other starting materials including Na, Li, Mn, Ni and M can be thoroughly mixed in a ball milling or slow rotation mixer for a suitable period of time (e.g. 5 to 20 hours), followed by a calcination of the mixture at a temperature in range of 600° C. to 1100° C. for 2 to 24 h.

A preferred co-precipitation method utilizes salts of Mn, Ni and M that can be dissolved in a container. The base, for example, NaOH or Na₂CO₃, is dissolved in another container. The transition metal solution is dropped into the base solution to form the co-precipitation products, for example, Ni_{z}MnᵤM_{y}(OH)_{b} or Ni_{z}MnᵤM_{y}CO₃. The Li/Na carbonates or hydroxides are mixed with co-precipitated precursor, The pre-calcination is performed at a temperature in range of 480° C. to 500° C. for 2 to 24 h, the final calcination is performed at a temperature in range of 600° C. to 1100° C. for 2 to 24 h.

A preferred sol-gel method prepares the sol solution from the stoichiometric mixture of Ni, Mn, and M salts in distilled water. A solution of Li/Na salts in distilled water and aqueous solution of citric acid was added dropwise to the metal precursor mixture with a continuous stirring. Next, the pH of the mixed solution was adjusted to 7 by adding an ammonium hydroxide solution. As-prepared sol solution was dried at 70° C. with a vigorous mechanical stirring. After gel formation, the precursor was further dried in vacuum oven at 120° C. for overnight, eventually, the resulting gel precursors were decomposed at a temperature in range of 480° C. to 500° C. for 2 to 24 h in air and then calcinated at a temperature in range of 600° C. to 1100° C. for 2 to 24 h in air.

A preferred polyol method adds the stoichiometric mixture of Ni, Mn, Li, Na, and M salts and citric acid to 100 ml tetraethylene glycol (TTEG) in a stioichiometric molar ratio. The mixture was heated at 280° C. for 3 h in a round bottom flask connected to a refluxing condenser to ensure full activation of the polyol medium. The resulting solution was centrifuged several times with methanol and subsequently dried at 80° C. for overnight. The resulting precursors were decomposed at a temperature in range of 480° C. to 500° C. for 2 to 24 h in air and then calcinated at a temperature in range of 600° C. to 1100° C. for 2 to 24 h in air.

A preferred hydrothermal method loads stoichiometric amounts of Ni, Mn, Li, Na, and M salts and Polyvinylpyrrolidone (Mw=10,000 g mol−1) were loaded into a poly(tetrafluoroethylene)-lined stainless steel autoclave, which was then filled with 3/4 of a solution of ethylene glycol and water (v:v=1:1). The autoclave was sealed and maintained at 200° C. for 12 hrs. The precursor was heated on a hot plate to evaporate the ethylene glycol and water. The resulting precursors were decomposed at a temperature in range of 480° C. to 500° C. for 2 to 24 h in air and then calcinated at a temperature in range of 600° C. to 1100° C. for 2 to 24 h in air.

Calcination and sintering of suitable mixed combination of salts, oxides, carbonate, hydroxides, or other starting materials including Na, Li, Mn, Ni and M can also be used to prepare the material. For example, such starting materials can be mixed in a ball milling or slow rotation mixer for a suitable period of time (e.g. 5 to 20 hours), followed by grinding and thermal reaction of the mixture. In one preferred embodiment, the material is prepared by calcinations of a combination of sodium carbonate, lithium hydroxide monohydrate and a co-precipitated precursor Mn/Ni hydroxide, hereby releasing H₂O and CO₂ as shown in Equation (1): 1.15LiOH.H₂O+0.025Na₂CO₃+0.8Ni_{0.25}Mn_{0.75}(OH)₂+0.3O₂→Li_{1.15}Na_{0.05}Ni_{0.2}Mn_{0.6}O₂+2.525H₂O+0.025CO₂.

In another preferred embodiment, the material is prepared by calcinations of a combination of sodium carbonate, lithium carbonate and a co-precipitated precursor Mn/Ni/Co hydroxide, hereby releasing H₂O and CO₂ as shown in Equation (2): 0.0665Li₂CO₃+0.5Na₂CO₃+Ni_{0.2}Mn_{0.467}CO_{0.2}(OH)_{1.734}+0.2835O₂→NaLi_{0.133}Ni_{0.2}Mn_{0.467}Co_{0.2}O₂+0.867H₂O+0.5665CO₂.

Optionally, one or more additional metal hydroxide/carbonates (M hydroxide/ carbonate) can be included in the reaction of Equation (1) and (2), with appropriate adjustment of the stoichiomtries of the precursors. The temperature of the calcinations is selected such that the mixture of precursor hydroxides/carbonates decomposes to the active layered phase for the cathode material. In a preferred embodiment the pre-calcination is performed at a temperature in range of 480° C. to 500° C. for 2 to 24 h, the final calcinations is performed at a temperature in range of 600° C. to 1100° C. for 2 to 24 h. The stoichiometries of the hydroxides or carbonates are selected such that a material of composition NaₓLi_{y}Ni_{z}MnᵤMᵥO_{w}, where in M compromises one or more metal cation, x+y≧0.9, (x+y)/(z+u+v)>1, 0≦z≦0.9, 0≦u≦0.9, 0≦v≦0.9, x+y+z+u+v is less than w, and the value of w depends on the proportions and average oxidation states of the metallic elements. The combined positive charge of the metallic elements is balanced by the number of oxygen anions, w. The cathode material of composition NaₓLi_{y}Ni_{z}MnᵤMᵥO_{w} is layered, with preferably good separation between the layers. The Na cations are predominately present in octahedral coordination in sodium layer, the Ni, Mn and M cations are preferentially located in octahedral coordination in the transition metal layer, and the Li cations are located in octahedral coordination in either transition metal layer or both transition metal layer and sodium layer depends on the amount of lithium ion in the structure. Preferred example compositions are Na_{0.05}Li_{1.15}Ni_{0.2}Mn_{0.6}O₂ and NaLi_{0.133}Ni_{0.2}Mn_{0.467}Co_{0.2}O₂.

In another preferred embodiment, the O3 type NaₓLi_{y}Ni_{z}MnᵤMᵥO_{w} cathode material can be prepared by ion-exchange. In experiments, the NaₓLi_{y}Ni_{z}MnᵤMᵥO_{w} cathode containing more lithium (y>0.6) was charged with various cut off voltage between 4.6 and 4.95 V (vs. Li metal, using LiPF₆ non-aqueous electrolyte) and discharged with various cut off voltage between 1.0 and 2.0 V (vs.Na metal, using NaPF₆ non-aqueous electrolyte), and the O3 type NaₓLi_{y}Ni_{z}MnᵤMᵥO_{w} cathode which contains more sodium (x>0.6) cathode was obtained. Three preferred example compositions are Na_{0.8}Li_{0.14}Ni_{0.3}Mn_{0.567}O_{w}, Na_{0.8}Li_{0.14}Ni_{0.25}Mn_{0.583}O_{w} and Na_{0.8}Li_{0.14}Ni_{0.16}Mn_{0.5}Co_{0.16}O_{w}.

Specifically, the ion-exchange procedure began with the NaₓLi_{y}Ni_{z}MnᵤMᵥO_{w} containing more lithium (y>0.6), which was made into a cathode and assembled with an Li anode. Then, this prepared cell is then charged with various cut off voltages between 4.6 and 4.95 V (vs. Li metal, using LiPF₆ non-aqueous electrolyte) to remove most of the Li from the cathode. After the lithium removal, the cell was opened and the cathode was washed. In the experiments, the cathode was washed three times. Afterwards, the cathode was assembled with a Na anode and discharged with various cut off voltage between 1.0 and 2.0 V (vs. Na metal, using NaPF₆ non-aqueous electrolyte) to insert Na, and produce the O3 type NaₓLi_{y}Ni_{z}MnᵤMᵥO_{w} cathode that contains more sodium (x>0.6). Three preferred example compositions achieved by ion exchange are Na_{0.8}Li_{0.14}Ni_{0.3}Mn_{0.567}O_{w}, Na_{0.8}Li_{0.14}Ni_{0.25}Mn_{0.583}O_{w} and Na_{0.8}Li_{0.14}Ni_{0.16}Mn_{0.5}Co_{0.16}O_{w}, where w is less than 2.

An example O3 type layered NaₓLi_{y}Ni_{z}MnᵤMᵥO_{w} cathode of the invention generally exhibits a strongly intense (highly crystalline) (003) layering peak (Cu Kα) in its X-ray Diffraction (XRD) pattern. In a preferred embodiment, the layered structure of the material has an XRD pattern that is similar to that of the reference compound, NaFeO₂ (ICSD reference code: 01-076-2299). The Na cations predominately are in an octahedral coordination between the close-packed, stacked oxygen anion layers, in an alternating three-layer arrangement, which can be designated as ABCABC packing. The Li cations are located in octahedral coordination in ABCABC packing structures, in either the transition metal layer or both the transition metal layer and sodium layer, which depends on the amount of lithium ion in the structure.

In a preferred embodiment, the oxidation state of Mn in the NaₓLi_{y}Ni_{z}MnᵤMᵥO_{w} is close to tetravalent. Preferably, the Ni in the NaₓLi_{y}Ni_{z}MnᵤMᵥO_{w} is cycled between about Ni²⁺ and about Ni⁴⁺ or oxidation states very close to these values in the preferred voltage window of approximately 1.5 to 4.5V vs. Na metal. The Ni oxidation state is close to Ni²⁺ in the discharged state, and preferably Ni⁴⁺ in the charged state, in order to maximize the capacity of the cathode and the amount of Na removed and inserted in to the structure. Preferably, the Na insertion and removal from the cathode has a charge balance that is limited to a theoretical value associated with redox change, therefore adding other M (metal cation) which may increase capacity or stabilize structure.

In a preferred embodiment, the voltage profile of an cathode of the present invention is a continuous single phase sloping intercalation shape after first charge, which is smooth between voltage cutoffs of about 1.5V to 4.5V. The O3 layer peaks of the XRD patterns of an cathode of the invention typically shifts as a function of the Na content. A single phase in evident after one charge/ discharge cycle, indicating that the NaₓLi_{y}Ni_{z}MnᵤMᵥO_{w} layered oxide generally retains its O3 single phase structure during charge-discharge cycle.

In another preferred embodiment, the voltage profile of an cathode of the present invention is a continuous single phase sloping intercalation shape after first charge, which is smooth between voltage cutoffs of about 1.5V to 4.5V. Then charge-discharge cycling between 1.5V to 4.2V. The O3 layer peaks of the XRD patterns of an cathode of the invention typically shifts as a function of the Na content. A single phase in evident after cycles, indicating that the NaₓLi_{y}Ni_{z}MnᵤMᵥO_{w} layered oxide generally retains its O3 single phase structure during charge-discharge cycles.

Embodiments of the invention were tested. An example electrochemical charge experiment of a cathode of the invention was in a lithium battery electrolyte with lithium metal as the anode. A typical battery exhibits a slope below 4.4V and a plateau at around 4.5V. After first charge, the battery was disassembled and the cathode was assembled in a sodium battery electrolyte with sodium metal as the anode. The sodium ions inserted into the structure during discharge with very reversible cycling of the battery at a capacity of about 205 mAh g⁻¹ to about 241 mAh g⁻¹ (depends on the composition).

Preferred embodiments of the invention will now be discussed with respect to experiments and experimental data. The invention is not limited to the details of the experiments, as will be understood by artisans.

### Example 1

An active layered phase Li_{1.15}Na_{0.05}Ni_{0.2}Mn_{0.6}O₂, cathode material was prepared by heating a mixture of about 0.79821 g LiOH.H₂O, 0.05306 g Na₂CO₃ and about 1.2 g Ni_{0.25}Mn_{0.75}(OH)₂. The hydroxides and carbonates were thoroughly mixed for about 6 hours in a ball milling and then ground with a mortar and pestle for about 30 minutes prior to heating. The resulting powder was placed in to a box furnace, and then heated to a decomposition temperature, e.g. about 480-500° C., over about 2 hours and held there for a sufficient time to achieve decomposition, e.g., about 5-12 hours. In the experiments, 12 hours was a typical time. This heating achieves decomposition of Ni_{0.25}Mn_{0.75}(OH)₂ to form Ni_{0.25}Mn_{0.75}Oₑ. The sample was allowed to cool to room temperature in the furnace. The pre-calcination product was then reground and placed in to a box furnace to react with LiOH, and then heated to a reaction temperature, e.g., about 800-1100° C., over about 3 hours and held there for a reaction time, e.g. about 3-24 hours. In the experiments, 12 hours was a typical time. This heating step reacts LiOH with with Ni_{0.25}Mn_{0.75}Oₓ and air to form the final product. The sample was allowed to cool to room temperature in the furnace. In each of the heating steps, a slow ramping rate is preferred, e.g., 5 degrees per minute.

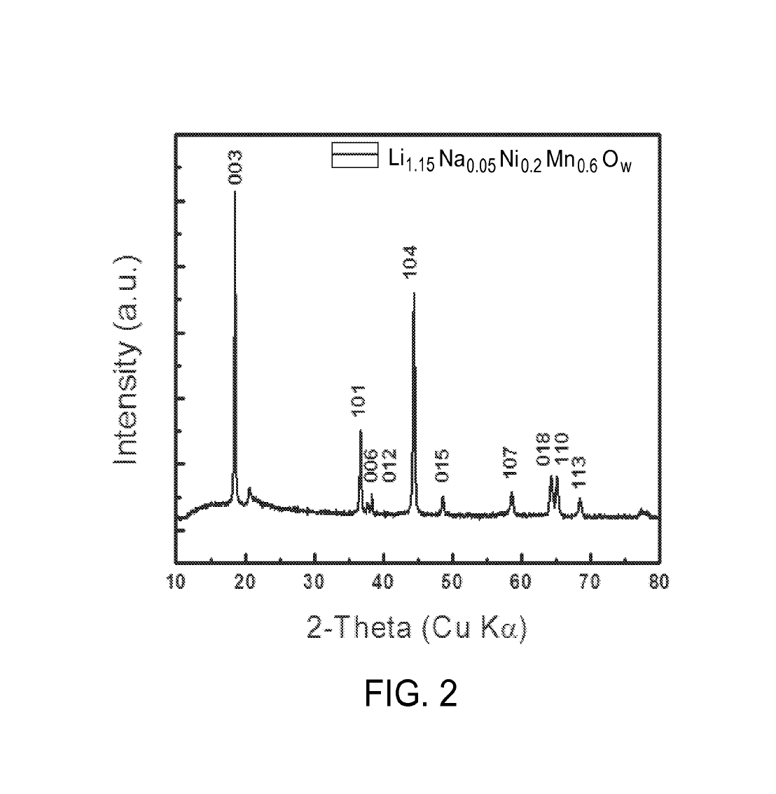

A sample of the Li_{1.15}Na_{0.05}Ni_{0.2}Mn_{0.6}O₂ cathode material was characterized by X-ray powder diffraction (XRD) using a Bruker D8 advance diffractometer with a Bragg—Brentano θ13 2θ geometry and a Cu Ka source. Samples were scanned from 10° to 80° with a scan rate of 0.025° per second. XRD spectra for the Li_{1.15}Na_{0.05}Ni_{0.2}Mn_{0.6}O₂ is depicted in FIG. 2. The major diffraction peaks of are indexed according to the parent hexagonal structure with space group R-3m, is similar to that of the reference compound, NaFeO₂ (ICSD reference code: 01-076-2299). This indicating an alternating three-layer arrangement which can be designated as ABCABC packing structure. The existence of doublets at (006)/(102) and (108)/(110) showed that the sample is well-layered structure. The peaks between 20-25° shows the superlattice structure indicated the existence of Li—Mn ordering in transition metal layer.

### Example 2

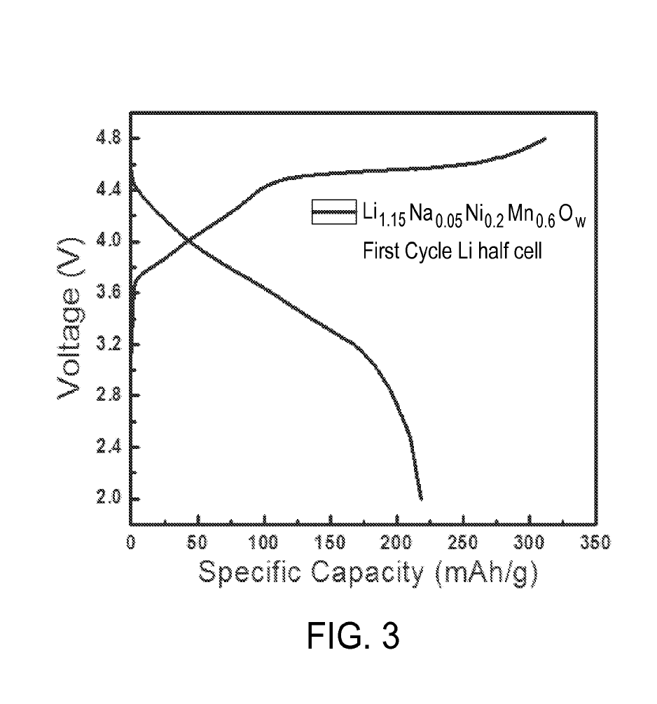

The material synthesized in Example 1 is a powder and was processed into cathode laminates. Each cathode were prepared by mixing cathode material with a conductive additive of 10 wt % Carbon Black and 10 wt % PVDF binder (inactive component) then added N-methyl pyrrolidone solvent. The slurry was cast onto an Al foil using a doctor blade and dried in a vacuum oven at 80° C. for 12 hours. The cathode disks were punched and dried again at 80° C. before storing them in an argon-filled glove box (H₂O level of <2 ppm). 2016 type coin cells were used to study the electrochemical behavior of the compounds. Lithium metal and 1 M LiPF₆ in a 1:1 ethylene carbonate: dimethyl carbonate solution were used as the counter electrode and electrolyte, respectively. A Celgard model C480 separator was used as the separator. The coin cells were assembled in an argon-filled glove box and tested on an Arbin battery cycler in galvanostatic mode. The tests were conducted between 2.0 and 4.8 V at a constant current rate of 12.5 mA/g. The Li/Li_{1.15}Na_{0.05}Ni_{0.2}Mn_{0.6}O₂ cell voltage profiles for the first cycle between 2.0 to 4.8V is shown in FIG. 3.

Other methods can be used to prepare a cathode from the cathode materials of the invention. For example, the powders can be mixed with PTFE and carbon black and pressed to be a thin disk. Such a thin disk is often used in a Swagelok cell.

### Example 3

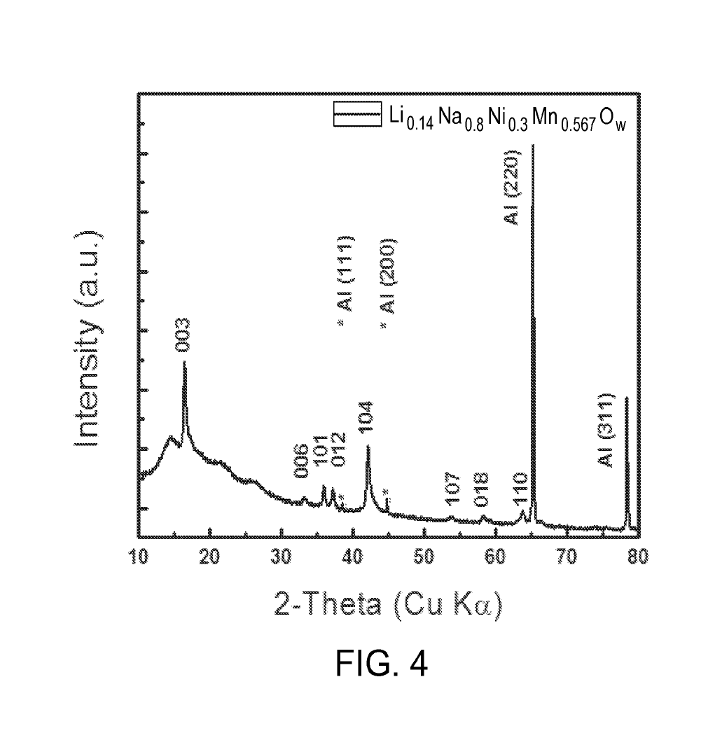

Following the reaction protocol in Example 1, the O3 type cathode material Li_{1.133}Ni_{0.3}Mn_{0.567}O₂ can be prepared using the appropriate mole stoichiometries of LiOH.H₂O and Ni_{0.25}Mn_{0.75}(OH)₂. Then, the Na_{0.8}Li_{0.14}Ni_{0.3}Mn_{0.567}O_{w} was prepared by ion-exchange. The Li_{1.133}Ni_{0.3}Mn_{0.567}O_{w} cathode which contains more lithium (y>0.6) was charged with cut off voltage at 4.8 V (vs. Li metal, using 1M LiPF_{6,} 1:1 EC:DMC) and discharged with cut off voltage 1.5 V (vs.Na metal, using 1M NaPF₆, 1:1 EC:DEC), thus O3 type Na_{0.08}Li_{0.14}Ni_{0.3}Mn_{0.567}O_{w} cathode which contains more sodium (x>0.6) cathode was obtained. XRD spectra for the Na_{0.08}Li_{0.14}Ni_{0.3}Mn_{0.567}O_{w} is depicted in FIG. 4.

Specifically, the reaction process in example 3, began with the Li_{1.133}Ni_{0.3}Mn_{0.567}O₂ containing more lithium (y>0.6), which was made into a cathode and assembled with Li anode. The prepared cell was charged with various cut off voltage at 4.8 V (vs. Li metal, using 1M LiPF_{6, 1:1} EC:DMC non-aqueous electrolyte) to remove of most Li in the electrode. Thirdly, this cell was opened and the electrode was washed with DMC for 3 times. In the last step, the electrode was assembled with Na anode and discharged to 1.5 V (vs.Na metal, using 1M NaPF_{6 , 1:1} EC:DEC non-aqueous electrolyte) to insert Na, and the O3 type Na_{0.8}Li_{0.14}Ni_{0.3}Mn_{0.567}O_{w} electrode which contains more sodium (x>0.6) electrode was obtained

The major diffraction peaks of are indexed according to the parent hexagonal structure with space group R-3m, is similar to that of the reference compound, NaFeO₂ (ICSD reference code: 01-076-2w299). This indicates an alternating three-layer arrangement which can be designated as ABCABC packing structure. The existence of doublets at (006)/(102) and (108)/(110) showed that the sample is well-layered structure. Compared with low Na content O3 layered oxide, Na_{0.8}Li_{0.14}Ni_{0.3}Mn_{0.567}O_{w} shows expanded lattice. The “a” lattice parameter is 2.9238 Å, and the “c” lattice parameter is 16.1878 Å, therefore we observed large shift of (003) peaks, and the (101) (006) peak position change, due to different d-spacing in large Na content O3 layered oxide.

### Example 4

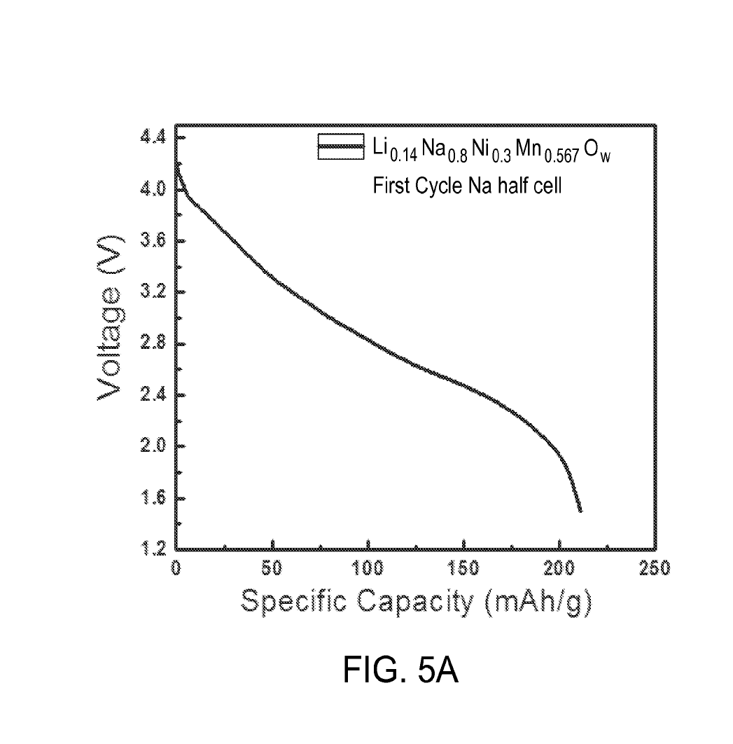

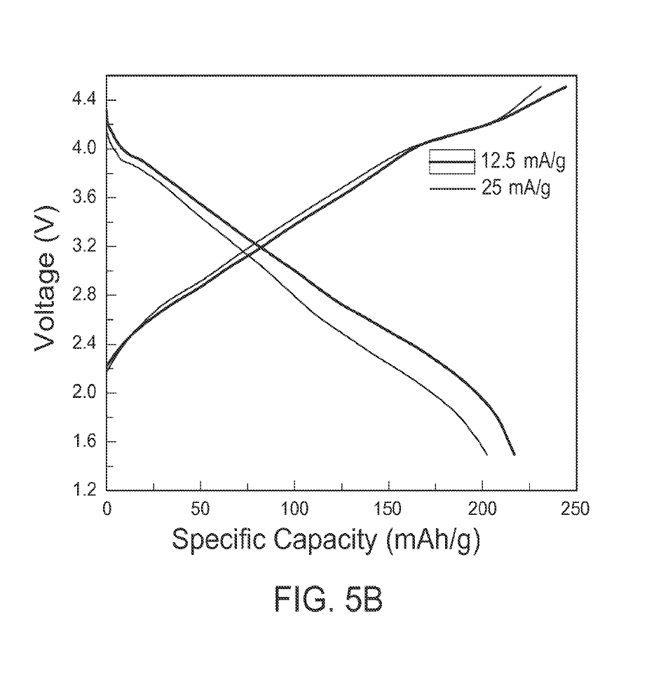

Na_{0.8}Li_{0.14}Ni_{0.3}Mn_{0.567}O_{w} prepared in Example 3 was tested in Na coin cells, using a cathode of the invention with an Na anode and an electrolyte of 1M NaPF₆, 1:1 EC:DEC. The first cycle discharge voltage profile of a typical Na/Na_{0.8}Li_{0.14}Ni_{0.3}Mn_{0.567}O_{w} cell between 4.5 and 1.5 V vs. Na metal at a current rate of 12.5 mA/g, is shown in FIG. 5A. The charge/discharge profile after first cycle at different current rate is shown in FIG. 5B.

The observed capacity was initially about 211 mAh g⁻¹ at 12.5 mAh g⁻¹, the discharge capacity at 25 mA g⁻¹ was about 202 mAh g⁻¹. This high capacity indicates a high energy density sodium ion battery cathode material. The charge/discharge profile within voltage window 1.5 to 4.5V is a smooth slope, which indicates that the Na_{0.8}Li_{0.14}Ni_{0.3}Mn_{0.567}O_{w} layered oxide generally retains its O3 single phase structure during charge-discharge cycle.

### Example 5

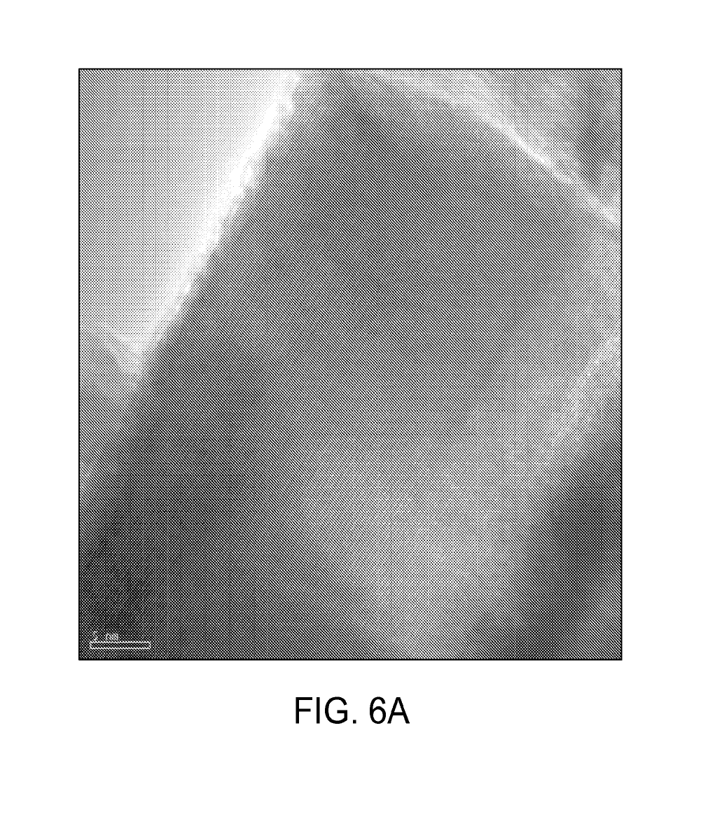

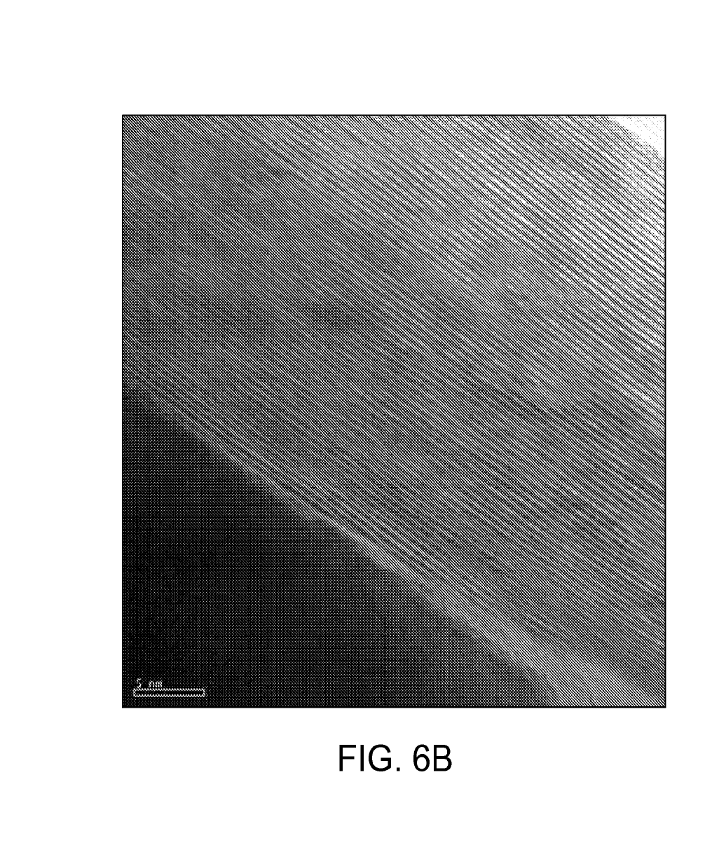

The Li_{1.13}Ni_{0.3}Mn_{0.567}O₂ and Na_{0.8}Li_{0.14}Ni_{0.3}Mn_{0.567}O_{w} were cycled in Li half cell and Na half cell respectively. The Li half-cell the cathode of the invention with an Li anode and an electrolyte of 1M LiPF₆, 1:1 EC:DMC. TEM images were collected on these cathode material after first cycle, using an FEI Tecnai G2 Sphera cryoelectron microscope with an operation voltage of 200 kV. The powders (scratched from the electrodes) were suspended on a 300-mesh copper grid with lacey carbon. FIG. 6A is a TEM image of Li_{1.13}Ni_{0.3}Mn_{0.567}O₂ cathode material extracted from a cell after one cycle vs. Li metal; FIG. 6B is a TEM image of Na_{0.8}Li_{0.14}Ni_{0.3}Mn_{0.567}O_{w} cathode material extracted from a cell after one cycle vs. Na metal. It is consistent that for the Li case after cycling, the layers are clearly retained as pristine. However, in the Na case after one cycle, the stacking fault, and layer sheering are observed in every checked particle. Such stacking fault and layer sheering only occurs at local scale with <10 nm domain size, no cracking or mechanical degradation is observed. This experiment shows the unique characteristics of different alkaline ions insertion. The stacking fault likely results from the larger size of Na ions.

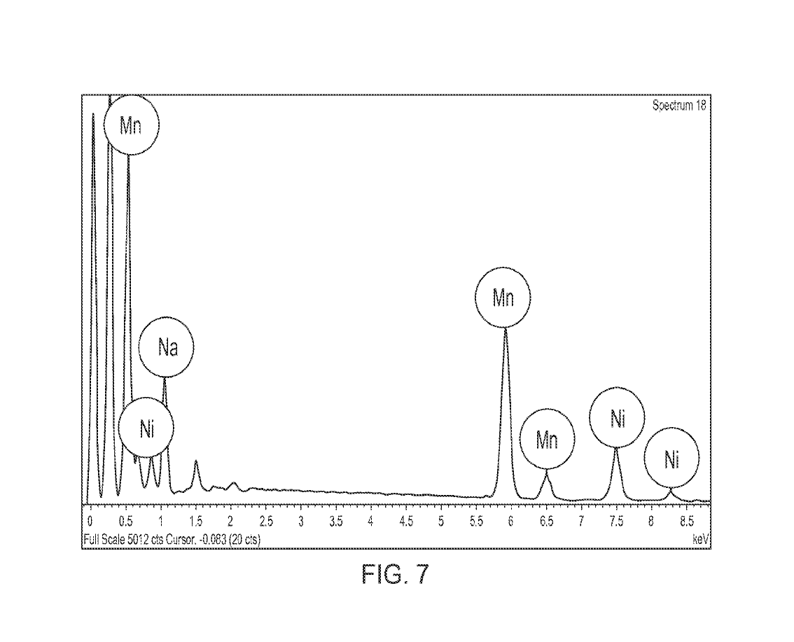

FIG. 7 is an EDX pattern of Na_{0.8}Li_{0.14}Ni_{0.3}Mn_{0.567}O_{w} cathode material extracted from a cell after one cycle vs. Na metal. The Na, Ni and Mn are analyzed quantitatively, the results shows around 0.8 Na, around 0.3 Ni and around 0.58 Mn in the structure, which is closed to the designed stoichiometry of the example cathode material.

### Example 6

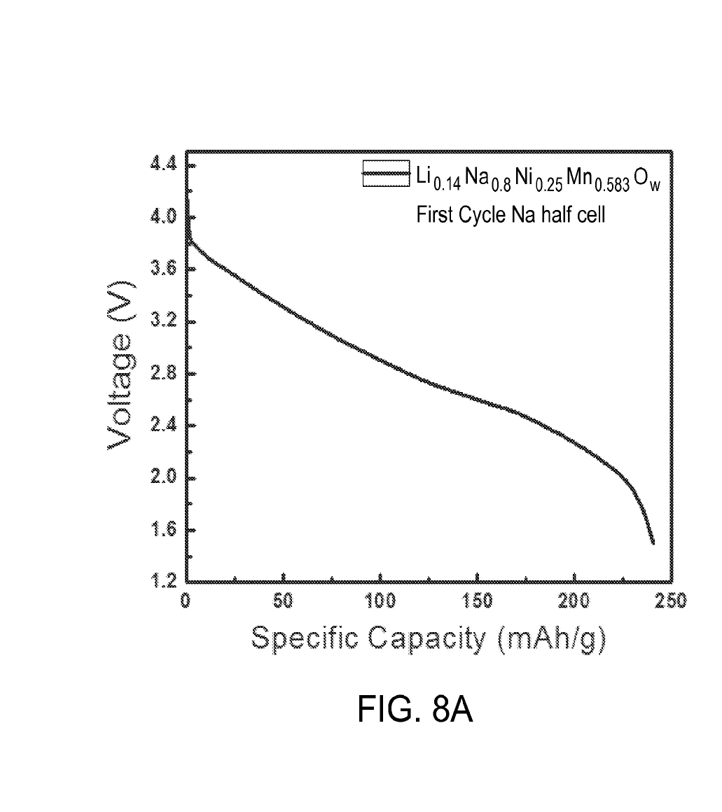

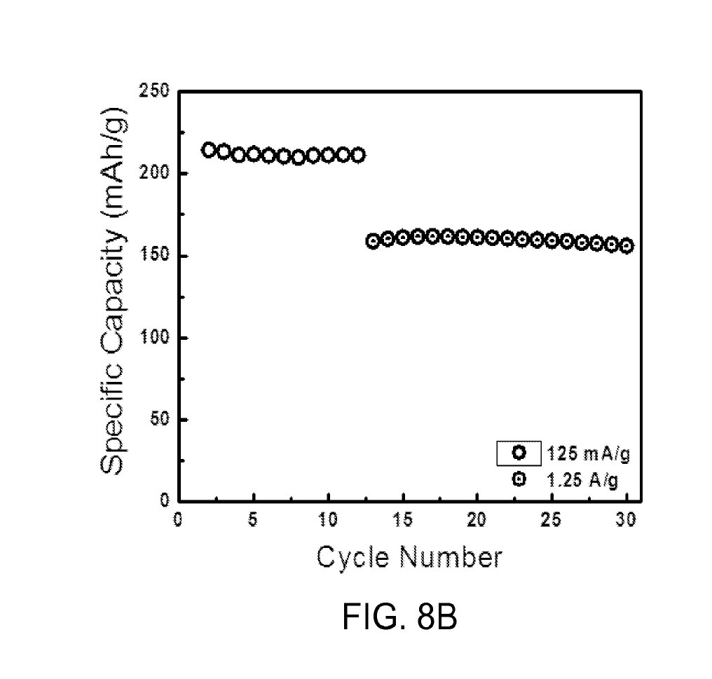

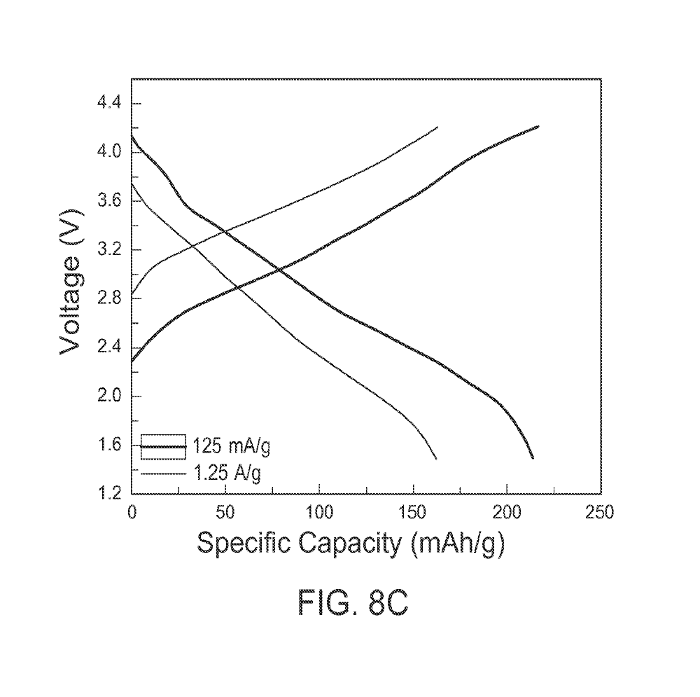

Na_{0.8}Li_{0.14}Ni_{0.25}Mn_{0.583}O_{w} synthesized followed by Example 3 was made into Na coin cells. The first cycle discharge voltage profile of a typical Na/Na_{0.8}Li_{0.14}Ni_{0.25}Mn_{0.583}O_{w} cell to 1.5 V vs. Na metal at a current rate of 12.5 mA/g, is shown in FIG. 8A. The discharge capacity vs cycles at 125 mA/g for 12 cycles, then change to 1.25 A/g over a voltage range of between 4.2V and 1.5V is shown in FIG. 8B. The comparison of the charge-discharge profile at different current density is shown in FIG. 8C.

The specific synthesis in this example began with the Li_{1.167}Ni_{0.25}Mn_{0.583}O₂ containing more lithium (y>0.6), which was made into a cathode and assembled with an Li anode. The prepared cell was charged with various cut off voltages at 4.8 V (vs. Li metal, using 1M LiPF₆, 1:1 EC:DMC non-aqueous electrolyte) to remove most of the Li from the cathode. The cell was opened and the electrode was washed with DMC for 3 times. In the last step, the electrode was assembled with Na anode and discharged to 1.5 V (vs. Na metal, using 1M NaPF₆, 1:1 EC:DEC non-aqueous electrolyte) to insert Na, and the O3 type Na_{0.8}Li_{0.14}Ni_{0.25}Mn_{0.583}O_{w} electrode which contains more sodium (x>0.6) electrode was obtained.

The observed capacity was initially about 241 mAh g⁻¹ at 12.5 mAh g⁻¹, the corresponding energy density was calculated to be 674 Wh/kg. The discharge capacity at 125 mA g⁻¹ between 1.5 and 4.2V was about 214 mAh g⁻¹. After 12 cycles, the capacity retention is >98%, indicates good reversibility. Even charge/ discharge current density improved to 1.25 A/g, it still delivered 161 mAh/g capacity, indicated excellent rate capability. This high capacity indicates a high energy density sodium ion battery cathode material. The charge/discharge profile within voltage window 1.5V to 4.2V is a smooth slope, which indicates that the Na_{0.8}Li_{0.14}Ni_{0.25}Mn_{0.583}O_{w} layered oxide generally retains its O3 single phase structure during charge-discharge cycles.

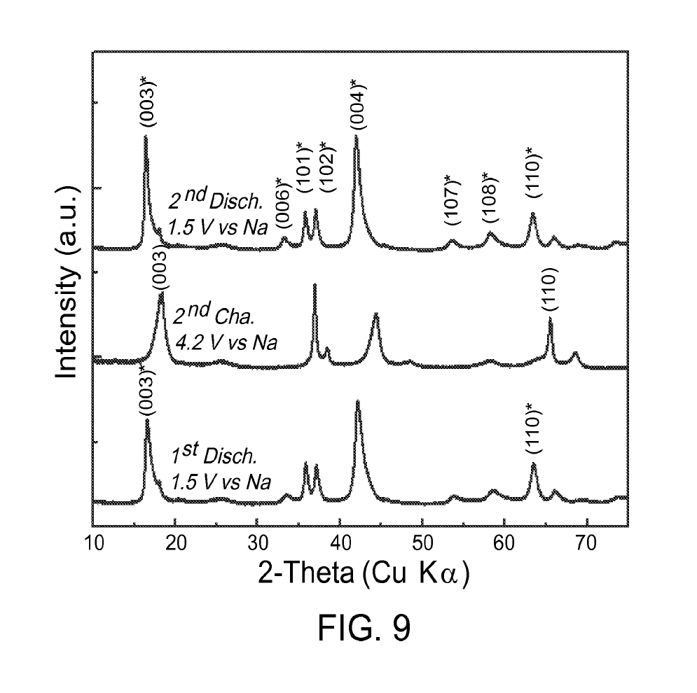

Synchrotron XRD spectra (converted to Cu Kα) for the Na_{0.8}Li_{0.14}Ni_{0.25}Mn_{0.583}O_{w} after different cycles are shown in FIG. 9. The major diffraction peaks are indexed according to the parent hexagonal structure with space group R-3m, is similar to that of the reference compound, NaFeO₂ (ICSD reference code: 01-076-2299). This indicates an alternating three-layer arrangement which can be designated as ABCABC packing structure indicates that the Na_{0.8}Li_{0.14}Ni_{0.25}Mn_{0.583}O_{w} layered oxide generally retains its O3 single phase structure during charge-discharge cycle. The “a” lattice parameter is 2.9316 Å, and the “c” lattice parameter is 16.0590 Å, therefore we observed large shift of (003) peaks, and the (101) (006) peak position change, due to different d-spacing in large Na content O3 layered oxide.

### Example 7

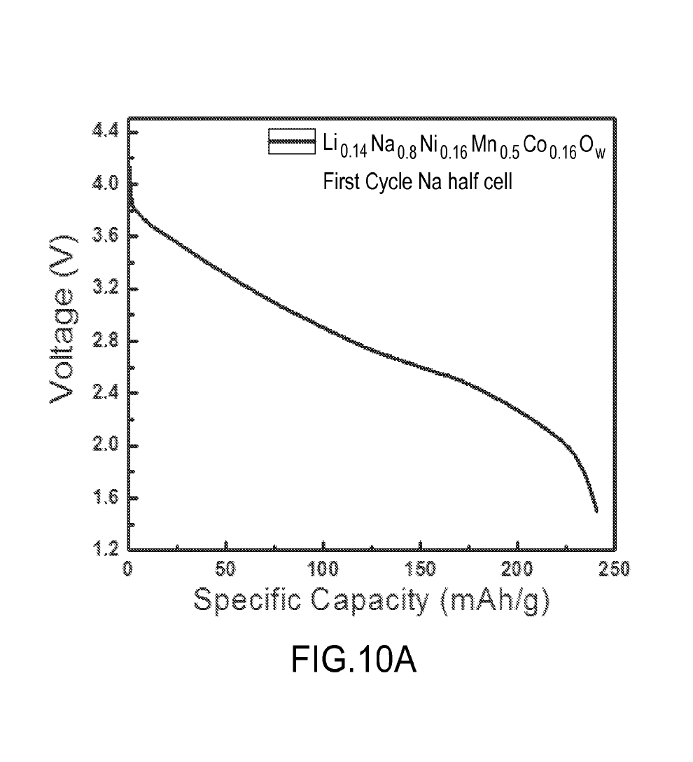

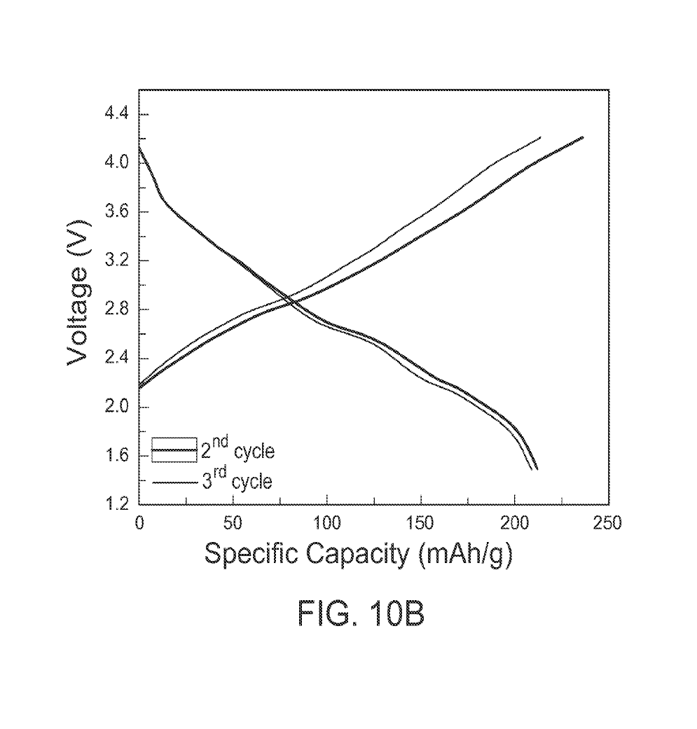

Na_{0.8}Li_{0.14}Ni_{0.16}Mn_{0.5}Co_{0.16}O_{w} synthesized followed by Example 3 was made into Na coin cells. The first cycle discharge voltage profile of a typical Na/Na_{0.8}Li_{0.14}Ni_{0.16}Mn_{0.5}Co_{0.16}O_{w} cell to 1.5 V vs. Na metal at a current rate of 12.5 mA/g, is shown in FIG. 10A. The charge/discharge profile after first cycle at 125 mA/g between 1.5 and 4.2V is shown in FIG. 10B. The observed capacity was initially about 243 mAh g⁻¹ at 12.5 mAh g⁻¹, the discharge capacity at 125 mA g^{-l}between 1.5V and 4.2V was about 212 mAh g⁻¹. This high capacity indicates a high energy density sodium ion battery cathode material. The charge/discharge profile within voltage window 1.5V to 4.2V is a smooth slope, which indicates that the Na_{0.8}Li_{0.14}Ni_{0.16}Mn_{0.5}Co_{0.16}O_{w} layered oxide generally retains its O3 single phase structure during charge-discharge cycle.

The specific synthesis began with the Li_{1.167}Ni_{0.16}Mn_{0.5}Co_{0.16}O₂ containing more lithium (y>0.6), which was made into a cathode and assembled with an Li anode. Various cut off voltage at 4.8 V (vs. Li metal, using 1M LiPF₆, 1:1 EC:DMC non-aqueous electrolyte) were applied to remove most of the Li from the electrode. The cathode was washed with DMC for 3 times. The cathode was assembled with an Na anode and discharged to 1.5 V (vs.Na metal, using 1M NaPF₆, 1:1 EC:DEC non-aqueous electrolyte) to insert Na, producing the O3 type Na_{0.8}Li_{0.14}Ni_{0.16}Mn_{0.5}Co_{0.16}O_{w} cathode which contains more sodium (x>0.6).

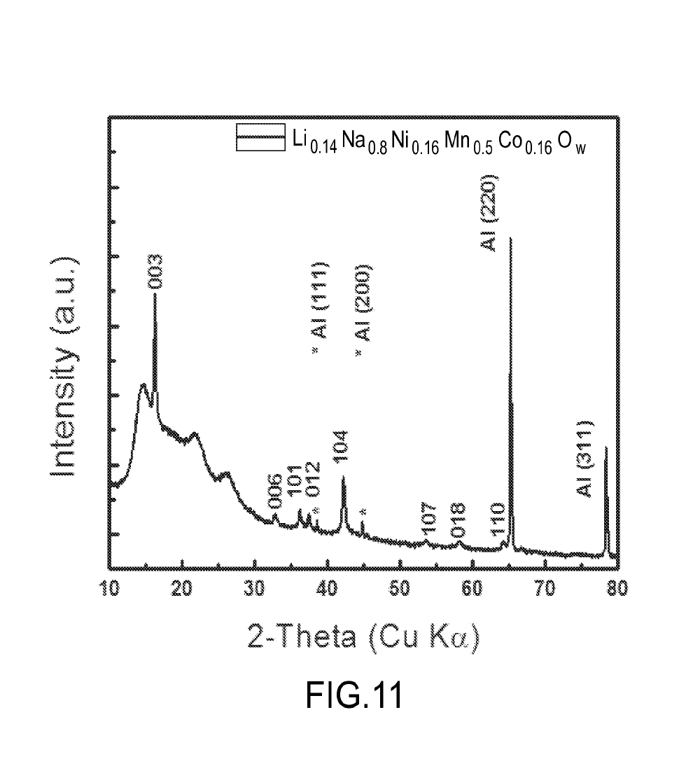

XRD spectra for the Na_{0.8}Li_{0.14}Ni_{0.16}Mn_{0.5}Co_{0.16}O_{w} after cycles is depicted in FIG. 11. The major diffraction peaks are indexed according to the parent hexagonal structure with space group R-3m, and the spectra is similar to that of the reference compound, NaFeO₂ (ICSD reference code: 01-076-2299). This indicates an alternating three-layer arrangement which can be designated as ABCABC packing structure indicates that the Na_{0.8}Li_{0.14}Ni_{0.16}Mn_{0.5}Co_{0.16}O_{w} layered oxide generally retains its O3 single phase structure during charge-discharge cycle. The “a” lattice parameter is 2.8994 Å, and the “c” lattice parameter is 16.3759 Å, therefore we observed large shift of (003) peaks, and the (101) (006) peak position change, due to different d-spacing in large Na content O3 layered oxide.

### Example 8

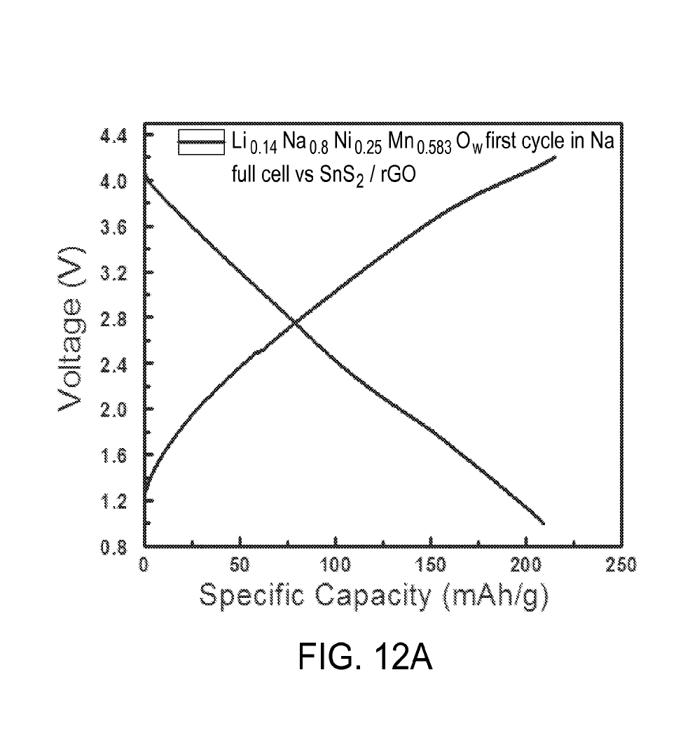

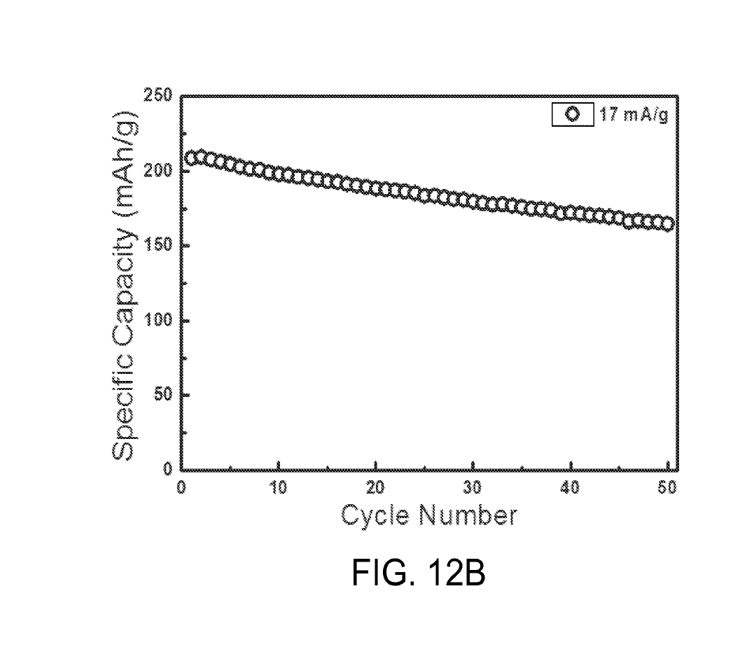

Na_{0.8}Li_{0.14}Ni_{0.25}Mn_{0.583}O_{w} synthesized followed by Example 3 was made into Na coin cells. The first cycle charge-discharge voltage profile of a typical SnS₂-rGO/Na_{0.8}Li_{0.14}Ni_{0.25}Mn_{0.583}O_{w} full cell over a voltage range between 4.2V and 1.0 V vs. SnS₂-rGO at a current rate of 17 mA/g, is shown in FIG. 12A. The discharge capacity vs cycles at 17 mA/g over a voltage range of between 4.2V and 1.0V is shown in FIG. 12B.

Specifically, synthesis began with the Li_{1.167}Ni_{0.25}Mn_{0.583}O₂ containing more lithium (y>0.6) was made into a cathode and assembled with an Li anode. Charging with various cut off voltages at 4.8 V (vs. Li metal, using 1M LiPF₆, 1:1 EC:DMC non-aqueous electrolyte) to remove most of the Li from the cathode. The cell was opened and the cathode was washed with DMC 3 times. The cathode was assembled with an Na anode and discharged to 1.5 V (vs.Na metal, using 1M NaPF₆, 1:1 EC:DEC non-aqueous electrolyte) to insert Na, forming the O3 type Na_{0.8}Li_{0.14}Ni_{0.25}Mn_{0.583}O_{w} cathode which contains more sodium (x>0.6).

The half cell with Na as anode was opened to get the Na_{0.8}Li_{0.14}Ni_{0.25}Mn_{0.583}O_{w} cathode. A full cell was assembled with Sn₂-rGO anode using 1M NaPF_{6 , 1:1} EC:DEC non-aqueous electrolyte.

The observed capacity was initially about 209 mAh g⁻¹ at 17 mAh g⁻¹, the energy density of this full cell was calculated to be 427 Wh/kg (considering both of the cathode and anode). This high capacity and high energy density sodium ion full battery can provide benefits to a wide variety of applications. The charge/discharge profile within voltage window 1.0V to 4.2V is a smooth slope, which indicates that the

Na_{0.8}Li_{0.14}Ni_{0.25}Mn_{0.583}O_{w} layered oxide generally retains its O3 single phase structure during charge-discharge cycles.

### Example 9

An active layered phase NaLi_{0.133}Ni_{0.2}Mn_{0.467}Co_{0.2}O₂, material was prepared by heating a mixture of Li₂CO₃, Na₂CO₃ and Ni_{0.2}Mn_{0.467}Co_{0.2}(OH)1.734. The hydroxides and carbonates were thoroughly mixed for about 6 hours in a ball milling and then ground with a mortar and pestle for about 30 minutes prior to heating. The resulting powder was placed into a box furnace, and then heated to about 480° C., over about 2 hours and held there for about 12 hours. The sample was allowed to cool to room temperature in the furnace. The pre-calcination product was then reground and placed in to a box furnace, and then heated to about 1000° C., over about 2 hours and held there for about 24 hours. The sample was quenched to room temperature in the furnace.

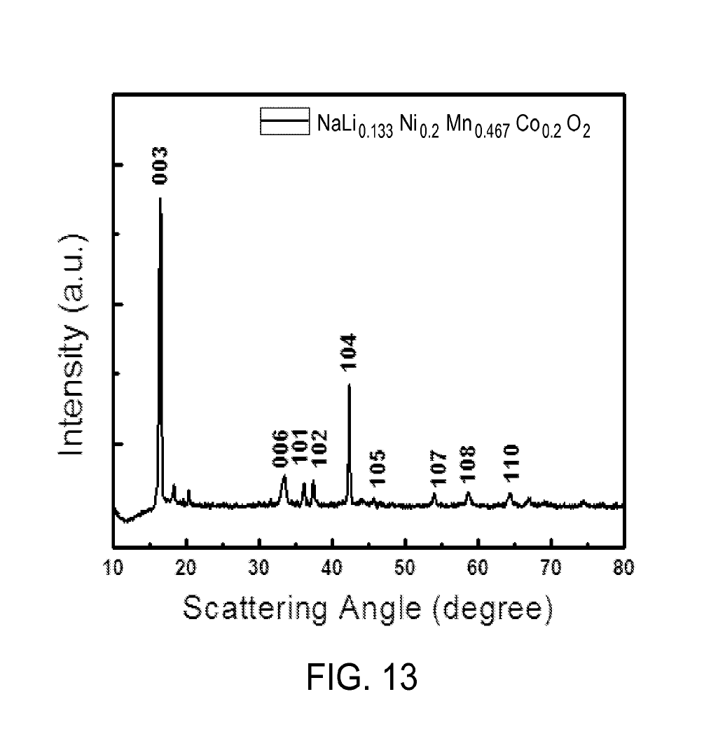

A sample of the NaLi_{0.133}Ni_{0.2}Mn_{0.467}Co_{0.2}O₂ was characterized by X-ray powder diffraction (XRD) using a Bruker D8 advance diffractometer with a BraggBrentano θ—2θ geometry and a Cu Kα source. Samples were scanned from 10° to 80° with a scan rate of 0.025° per second. XRD spectra for the NaLi_{0.133}Ni_{0.2}Mn_{0.467}Co_{0.2}O₂ is depicted in FIG. 13. The major diffraction peaks are indexed according to the parent hexagonal structure with space group R-3m, and the spectra is similar to that of the reference compound, NaFeO₂ (ICSD reference code: 01-076-2299). This indicates an alternating three-layer arrangement which can be designated as ABCABC packing structure. The existence of doublets at (006)/(102) and (108)/(110) showed that the sample is well-layered structure.

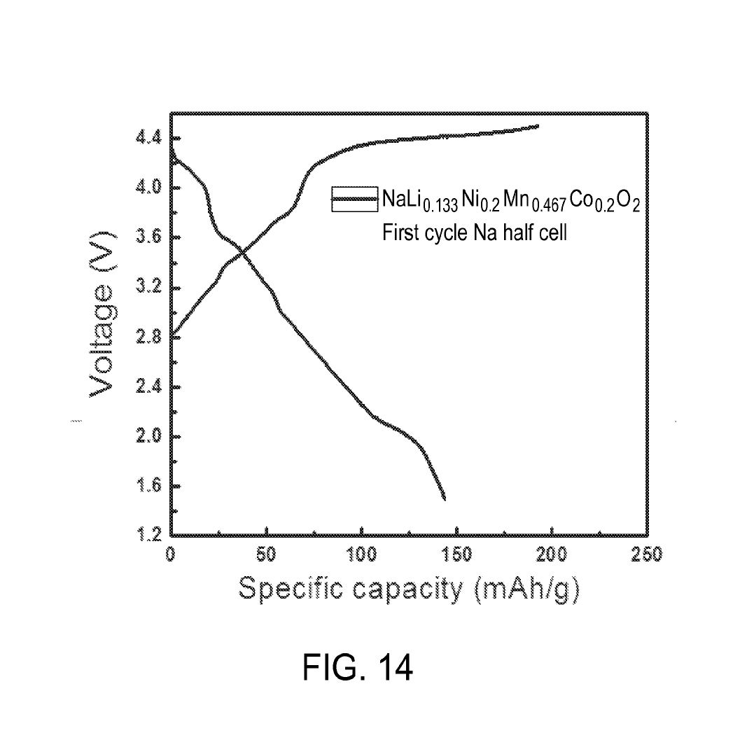

The tests of NaLi_{0.133}Ni_{0.2}Mn_{0.467}Co_{0.2}O₂ were conducted between 1.5 and 4.5 V at a constant current rate of 25 mA/g. The Na/NaLi_{0.133}Ni_{0.2}Mn_{0.467}Co_{0.2}O₂ cell voltage profiles for the first cycle between 1.5 to 4.5V. The data are shown in FIG. 14. The initial discharge capacity was about 144 mAh/g at 25 mA/g.

### Battery

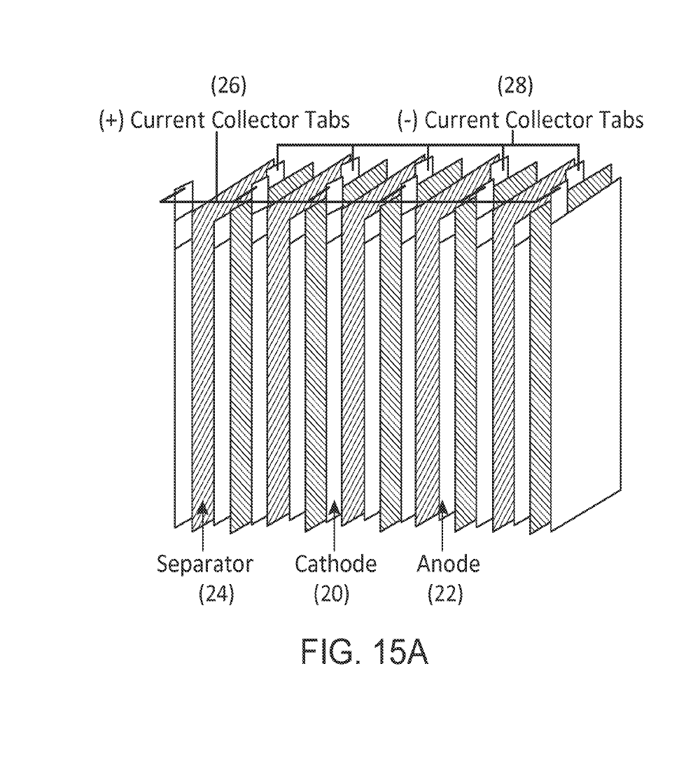

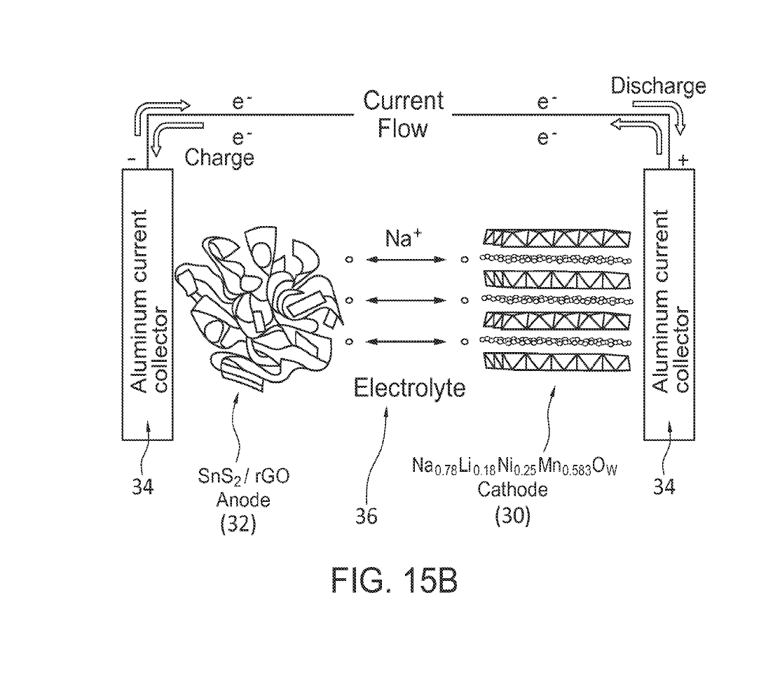

FIG. 15A illustrates a preferred battery of the invention that can be formed with preferred example cathodes, including but not limited to the experimental cathodes from the above examples. In FIG. 15A, the cell of the battery is illustrated without an enclosure for clarity. Electrolyte is also omitted for simplicity of illustration. The cell includes repeating plates of cathode 20, anode 22, and separator 24. Al current collector tabs/contacts 26 are electrically connected to the cathode 20 and additional Al tabs/contacts 28 are electrically connected to the anode 22. The cathode plates 20 are formed from the preferred O3 cathode materials of the invention.

### Fuel Cell

FIG. 15B illustrates a preferred fuel cell of the invention, including a cathode 30 of the invention that is separated from an anode 32. Current is collected via metal collectors 34, which can be aluminum, for example. An electrolyte 36 provides the ion transport. A preferred example electrolyte is 1M NaPF₆, 1:1 EC:DEC non-aqueous electrolyte.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. An material for use as a cathode in a sodium ion electrochemical cell or battery, comprising a lithium and sodium containing layered oxide of the formula NaₓLi_{y}Ni_{z}MnᵤMᵥO_{w}, where M comprises one or more metal cations.

2. The material of claim 1, wherein the one or more metal cations are selected from one or more divalent, trivalent, tetravalent, pentavalent or hexavalent cations.

3. The material of claim 2, wherein the one or more metal cations are selected from one or more Mg²⁺, Cu²⁺, Co³⁺, B³⁺, Fe³⁺, Al³⁺, Ti⁴⁺, Zr⁴⁺, V⁵⁺, and Cr⁶⁺ etc.

4. The material of claim 1, wherein the layered oxide structure is O3 type

5. The material of claim 1, wherein (x+y)/(z+u+v)>1

6. The material of claims 1, wherein x+y≧0.9, 0≦z≦0.9, 0≦u≦0.9, 0≦v≦0.9, x+y+z+u+v is less than w.

7. The material of claim 1, having a reversible capacity>120 mAh g⁻¹,

8. The material of claim 7, having a reversible capacity>200 mAh g⁻¹,

9. The material of claim 1, consisting of Na_{0.05}Li_{1.15}Ni_{0.2}Mn_{0.6}O₂.

10. The material of claim 1, consisting of Na_{0.8}Li_{0.14}Ni_{0.25}Mn_{0.583}O_{w}.

11. The material of claim 1, consisting of Na_{0.8}Li_{0.14}Ni_{0.16}Mn_{0.5}Co_{0.16}O_{w}.

12. The material of claim 1, consisting of NaLi_{0.133}Ni_{0.2}Mn_{0.467}Co_{0.2}O₂.

13. The material of claim 1, wherein the material includes Na cations predominately in an octahedral coordination between close-packed, stacked oxygen anion layers, in an alternating three-layer arrangement.

14. The material of claim 13, wherein the material includes Li cations are located in octahedral coordination in one of the transition metal layer or both the transition metal layer and sodium layer.

15. An electrochemical cell comprising a cathode formed of the material claim 1, an anode and an electrolyte.

16. The electrochemical cell of claim 15, wherein the anode comprises a Li metal anode and the electrolyte comprises 1 M LiPF₆ in a mixture of ethylenecarbonate (EC) and dimethylcarbonate (DMC) in a weight ratio of about 1:1 EC:DMC.

17. The material of claim 1, wherein oxidation state of Mn in the NaₓLi_{y}Ni_{z}MnᵤMᵥO_{w} is close to tetravalent.

18. The material of claim 1, wherein w is less than 2.

19. A cathode for a sodium ion electrochemical cell or battery comprising a material of claim 1, and a solidifier.

20. The cathode of claim 19, wherein the solidifier comprises 10 wt % Carbon Black, 10 wt % PVDF binder and N-methyl pyrrolidone solvent.

21. A method for synthesizing NaₓLi_{y}Ni_{z}MnᵤMᵥO_{w}, where M comprises one or more metal cations, the method comprising:
providing precursors of sodium carbonate, lithium hydroxide monohydrate and a co-precipitated precursor Mn/Ni hydroxide; and
calcinating the precursors to release H₂O and CO₂ according to Equation (1): 1.15LiOH.H₂O+0.025Na₂CO₃+0.8Ni_{0.25}Mn_{0.75}(OH)₂+0.3O₂→Li_{1.15}Na_{0.05}Ni_{0.2}Mn_{0.6}O₂+2.525H₂O+0.025CO₂.

22. The method of claim 21, wherein said calcinating comprises pre-calcinating at a temperature in range of 480° C. to 500° C. for 2 to 24 h, followed final calcinations is performed at a temperature in range of 600° C. to 1100° C. for 2 to 24 h.

23. A method for synthesizing NaₓLi_{y}Ni_{z}MnᵤMᵥO_{w}, where M comprises one or more metal cations, the method comprising:
providing precursors of sodium carbonate, lithium hydroxide monohydrate and a co-precipitated precursor Mn/Ni/Co hydroxide; and
calcinating the precursors to release H₂O and CO₂ according to Equation (2): 0.0665Li₂CO₃+0.5Na₂CO₃+Ni_{0.2}Mn_{0.467}CO_{0.2}(OH)_{1.734}+0.2835O₂→NaLi_{0.133}Ni_{0.2}Mn_{0.467}Co_{0.2}O₂+0.867H₂O+0.5665CO₂.

24. The method of claim 23, wherein said calcinating comprises pre-calcinating at a temperature in range of 480° C. to 500° C. for 2 to 24 h, followed final calcinations is performed at a temperature in range of 600° C. to 1100° C. for 2 to 24 h.

25. A method for synthesizing NaₓLi_{y}Ni_{z}MnᵤMᵥO_{w}, where M comprises one or more metal cations, the method comprising:
mixing appropriate stoichiometries of oxides, carbonate, hydroxides, or other starting materials including Na, Li, Mn, Ni and M; and
calcinating the mixture at a temperature in range of 600° C. to 1100° C. for 2 to 24 h to obtain the NaₓLi_{y}Ni_{z}MnᵤMᵥO_{w} material.

26. A method for synthesizing NaₓLi_{y}Ni_{z}MnᵤMᵥO_{w} (y<0.4) (x>0.6), where M comprises one or more metal cations, the method comprising:
assembling a cell with an NaₓLi_{y}Ni_{z}MnᵤMᵥO_{w} (y>0.6) cathode and an Li anode;
charging the cell to remove Li from the cathode;
cleaning the cathode;
assembling a second cell with the cathode and an Na anode; and
charging the cell to insert Na into the cathode.
